(19) United States
(12) Patent Application Publication
(10) Pub. No.: US 2004/0060288 A1
(43) Pub. Date: Apr. 1, 2004

(54) Hydraulic travel controller with integrated brake release

(76) Inventors: Michael D. Wetzel, Bismarck, ND (US); Daniel J. Krieger, Bismarck, ND (US)

Correspondence Address: John Veldhuis-Kroeze, WESTMAN CHAMPLIN & KELLY, International Centre - Suite 1600, 900 South Second Avenue, Minneapolis, MN, 55402-3319, US

(21) Appl. No.: 10/255,346

(22) Filed: Sep. 26, 2002

(51) Int. Cl. F16D 65/24

(52) U.S. Cl. 60/435

(57) ABSTRACT

A hydraulic travel controller, for use in controlling travel of a hydraulically driven machine, includes a travel control portion coupled to an operator mechanical user interface by a linkage. The travel control portion has an inlet hydraulically coupled to a pressure source. The travel control portion provides a plurality of outputs for controlling travel of the machine in response to positioning of the operator mechanical user interface. A brake control portion of the travel controller is hydraulically coupled to the plurality of outputs of the travel control portion. The brake control portion has an output hydraulically coupled to an input of a travel brake of the hydraulically driven machine. In response to a pressure at one or more of the plurality of outputs of the travel control portion, the brake control portion provides a pressure to the travel brake to thereby engage or disengage the travel brake.

### BACKGROUND OF THE INVENTION

The present invention relates to hydraulically driven machines. More particularly, the present invention relates to hydraulic travel controllers.

In hydraulically driven machinery such as mini-excavators (also known as compact excavators) or other work machines, the travel system utilizes a hydraulic, double-axis controller (a “travel controller”) to control the travel direction and speed of the machine. The travel controller typically has an inlet, four outputs or outlets, and a drain. The inlet is connected to a pressure source. The outputs of the travel controller control either one or more directional valves, such as hydraulic pilot-actuated spool valves, or one or more pump swashplates. The drain is connected to the system tank. A mechanical linkage between the travel controller and the operator allows operator control of the travel controller, and thus control of travel of the machine. Travel controllers of this type are not specific to mini-excavators, but rather are used in a wide variety of hydraulically driven machinery.

When the travel system is equipped with hydraulic spring-applied, pressure-release travel brakes, a hydraulic cartridge valve is typically required to control the brake. The cartridge valve is typically located in a remote manifold separate from the travel controller. Typically, an electric switch controls the cartridge valve, and thus the brake.

In current machinery, the existing travel controller and travel brake controls have a number of limitations. First, the travel controller has no mechanism for controlling the travel brakes. Further, with the external cartridge valve required to control the travel brakes, additional hydraulic plumbing is required, adding complexity to the manufacturing process, as well as the potential for increased material costs. Also, the additional hydraulic plumbing required for the travel brake controlling cartridge valve, located in a remote manifold, provides additional opportunity for leaks or other failures in the hydraulic system.

A third problem associated with current travel controller and travel brake designs is that the cartridge valve is controlled with an electric switch. The electric switch must be protected from accidental damage during use of the machine. Further, an electric switch control requires adjustment. Like the extra hydraulic plumbing, adjustments add to the system complexity and cost, and also increase assembly time, and thus manufacturing complexity and cost.

Consequently, a hydraulic travel controller and travel brake controller which addresses one or more of the above-identified problems, or other problems not discussed, or which provides other advantages over the prior art, would be a significant improvement in the art.

### SUMMARY OF THE INVENTION

A hydraulic travel controller, for use in controlling travel of a hydraulically driven machine, includes a travel control portion coupled to an operator mechanical user interface by a linkage. The travel control portion has an inlet hydraulically coupled to a pressure source. The travel control portion provides a plurality of outputs for controlling travel of the machine in response to positioning of the operator mechanical user interface. A brake control portion of the travel controller is hydraulically coupled to the plurality of outputs of the travel control portion. The brake control portion has an output hydraulically coupled to an input of a travel brake of the hydraulically driven machine. In response to a pressure at one or more of the plurality of outputs of the travel control portion, the brake control portion provides a pressure to the travel brake to thereby engage or disengage the travel brake.

### BRIEF DESCRIPTION OF THE DRAWINGS

FIG. 1 is a perspective view of a machine which utilizes a hydraulic travel controller with integrated brake release in accordance with embodiments of the present invention.

FIG. 2-1 is a block diagram illustrating a travel brake, a mechanical user interface, and a hydraulic travel controller with integrated brake release which can be used in the machine shown in FIG. 1 or in other types of hydraulically driven machinery.

FIG. 2-2 is a diagrammatic perspective view of the mechanical user interface and the hydraulic travel controller shown in FIG. 2-1 in accordance with one example embodiment of the present invention.

FIG. 3-1 is a hydraulic diagram illustrating the hydraulic travel controller with integrated brake release of the present invention with a travel brake controlling sequence valve shown in a neutral position.

FIG. 3-2 is a hydraulic diagram illustrating the hydraulic travel controller with integrated brake release of the present invention as shown in FIG. 3-1, but with the travel brake controlling sequence valve shown in an active position.

### DETAILED DESCRIPTION OF THE PREFERRED EMBODIMENTS

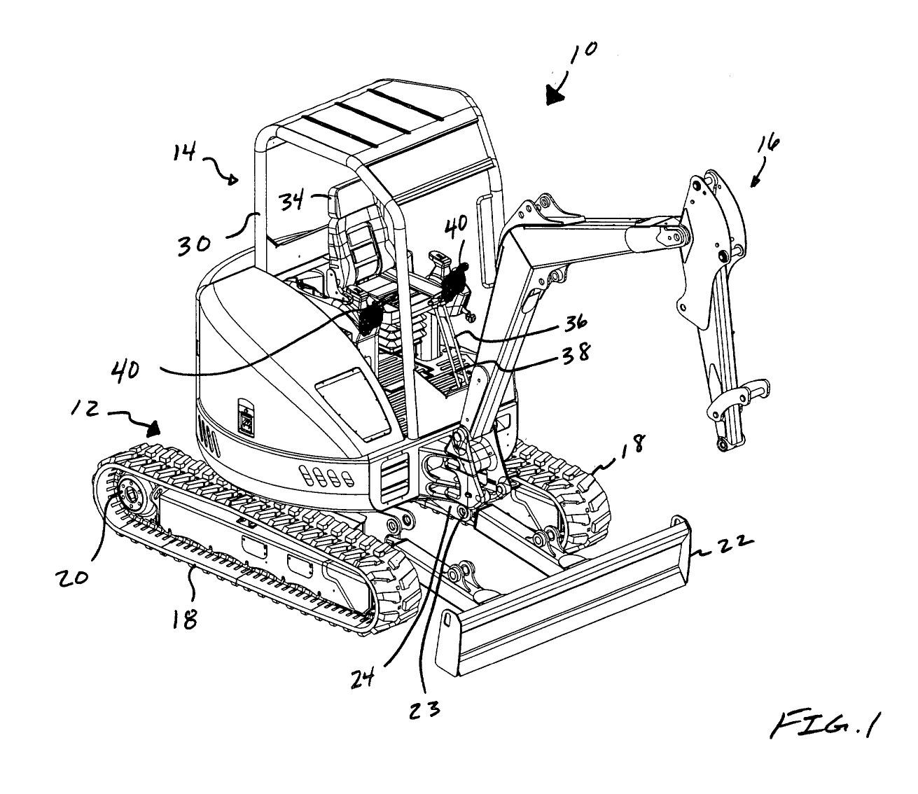

FIG. 1 is a perspective view of a hydraulically driven machine 10 according to the present invention. In the illustrated embodiment, machine 10 is a mini-excavator. However, the present invention is not limited to a particular type of hydraulically driven machine. Instead, the present invention is directed to a hydraulic travel controller which can be used in a wide variety of hydraulically driven machines.

The illustrated mini-excavator embodiment of machine 10 includes a base portion 12, an operator support portion 14, and an implement assembly 16 (such as a dipper assembly or other implement types commonly used with mini-excavators and other machines). Base 12 includes a pair of tracks 18 on left and right sides of the mini-excavator.

On each of the left and right sides of the mini-excavator, tracks 18 are rotatable about a pair of hubs 20 (only one hub is shown in FIG. 1). On each side of the mini-excavator, at least one of hubs 20 is driven by a hydraulic motor and system which includes, and is controlled by, a travel controller 200 (shown in FIGS. 2-1, 2-2, 3-1 and 3-2) to provide travel. The hydraulic systems are controlled by the operator through manipulation of suitable controls in operator support portion 14.

Base 12 also includes a blade 22 which is pivotally coupled to a frame 24 of the base at a pivot point 23. Hydraulic cylinders (not shown in FIG. 1) are selectively provided with hydraulic fluid under pressure. The operator, upon the manipulation of appropriate controls, can raise and lower blade 22 by controlling the hydraulic power circuit.

Operator support 14 is supported by base 12 and includes a canopy or cab 30 which is rotatably coupled to the frame of base 12. While positioned on a seat 34 within canopy or cab 30, the operator can control the travel of the mini-excavator using travel control devices or mechanisms, such as hand controls. In one embodiment, the hand controls include a pair of steering levers 36 and 38, as well as other joysticks 40 or other types of hand controls. Typically, first and second (for example left and right) travel control devices are each mechanically linked or coupled to a travel controller, which controls one or more hydraulic travel systems to drive track assemblies 18 (for example via hubs 20).

Steering levers 36 and 38 (or other travel control devices) are manipulated by the operator to steer the mini-excavator. For example, pushing forward on lever 36 causes the travel controller to the control the hydraulic travel system associated with lever 36 to drive the corresponding left or right track 18 in the forward direction. Pulling back on lever 36 causes the travel controller to control the hydraulic travel system associated with lever 36 to drive the corresponding track 18 in the reverse direction. The relative forward or rearward positions of lever 36 controls the speed of travel of the corresponding track 18 in the forward or reverse directions. The same is true of lever 38 and its associated hydraulic travel system and track 18 which are also under the control of the travel controller. Other joysticks, such as joysticks 40, can be used by the operator to control other hydraulic actuators on the mini-excavator or other machine 10.

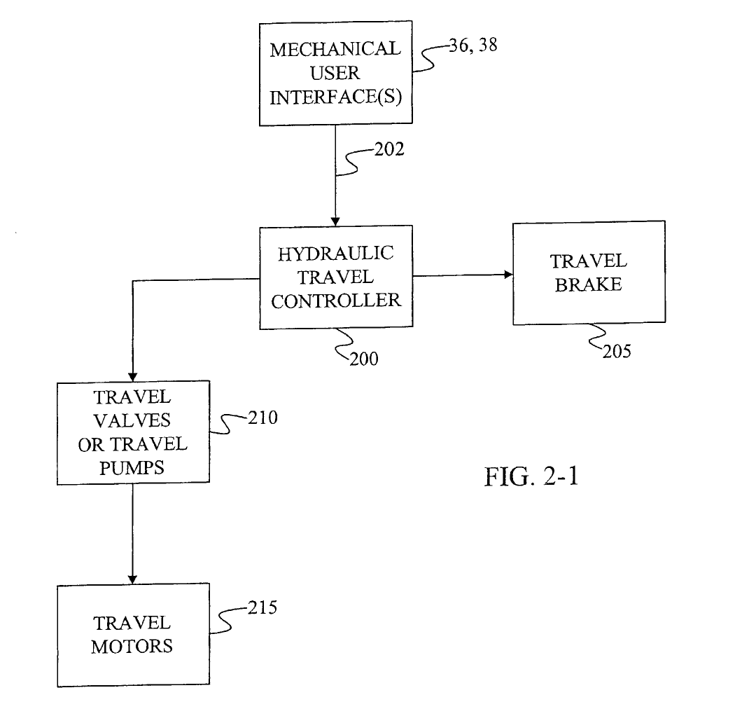

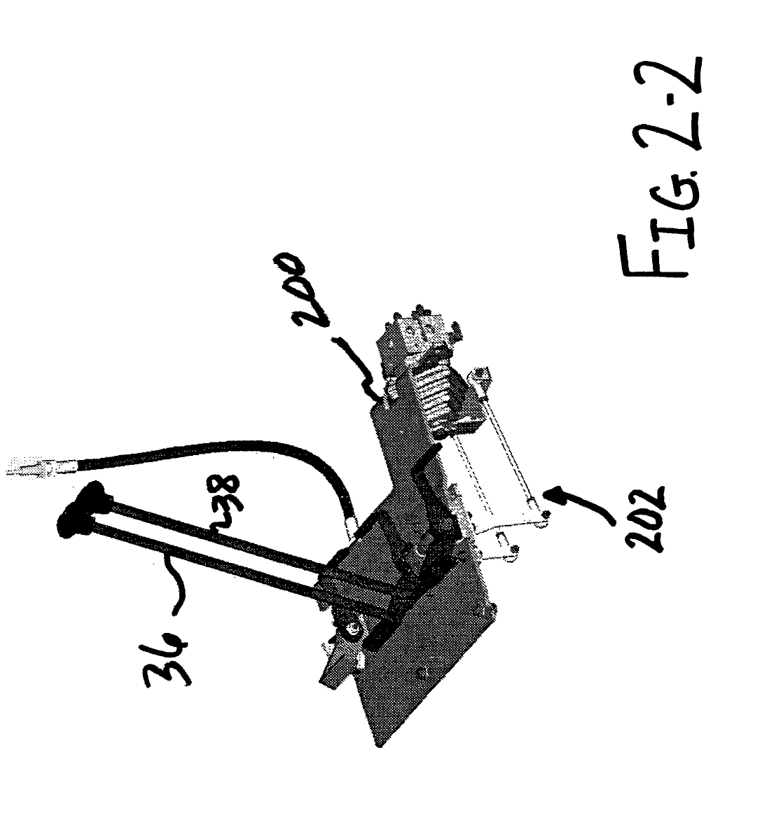

FIG. 2-1 is a block diagram illustrating a hydraulic travel controller 200 and other systems of the hydraulically driven machine 10. As shown in FIG. 2-1, mechanical user interfaces, such as steering or travel levers 36 and 38, are coupled to hydraulic travel controller 200 by a linkage 202. Levers 36 and 38, linkage 202 and hydraulic travel controller 200 are also illustrated in the perspective view of these components shown in FIG. 2-2.

In response to the operator manipulating levers 36 and 38, hydraulic travel controller 200 hydraulically controls travel valves or pumps 210 of a hydrostatic drive system. The travel valves or travel pumps 210 in turn drive or control travel motors 215, of the hydraulic systems, coupled to track assemblies 18 via hubs 20. In this manner, steering and travel of machine 10 is controlled.

A hydraulic spring-applied, pressure-release travel brake 205 prevents travel of machine 10 prior to sufficient pressure being built-up, in response to manipulation of levers 36 and 38, to cause travel of machine 10. As is discussed below in greater detail with reference to FIGS. 3-1 and 3-2, hydraulic travel controller 200 includes features which allow the efficient control of travel brake 205 without the conventional hydraulic cartridge valve located in a remote manifold, and without the electric switch which controls the conventional cartridge valve.

FIG. 3-1 and 3-2 are hydraulic diagrams illustrating hydraulic travel controller 200, which includes an integrated brake release, in accordance with the present invention. Hydraulic travel controller 200 includes a travel control portion or section 212 and a brake control portion or section 230. Travel control portion 212 and brake control portion 230 are formed in the same valve block in order to reduce system complexity and hydraulic plumbing.

Travel control portion 212 of hydraulic travel controller 200 includes an inlet 203 connected to a pressure source 201. Four outputs 222 are hydraulically coupled to travel valving or travel pumps 210 used to drive the travel motors (not shown in FIGS. 3-1 and 3-2) in order to control travel of machine 10. Travel controller 200 also includes an output 256 which is hydraulically coupled to travel brake 205 to facilitate the automatic engagement or release of travel brake 205 in accordance with the invention.

Included in travel control section 212 of travel controller 200 are four valves 215 (valves 215A, 215B, 215C and 215D), each of which has an inlet port 217 hydraulically coupled to inlet 203, and thereby to pressure source 201. Each of valves 215 also includes a drain port 218 hydraulically coupled to system drain 219, and an output port 220 hydraulically coupled to one of outputs 222, and thereby to travel valving or travel pumps 210. Under the control of mechanical user interfaces such as levers 36 and 38, which are coupled to valves 215 via mechanical linkages 202, the flow of hydraulic fluid from pressure source 201 which is provided at outputs 220/222 for the control of vehicle travel is adjusted as desired by the operator.

Brake control section 230 of travel controller 200 includes a shuttle valve network 231 which is hydraulically connected to outputs 220 of each of valves 215. Brake control section 230 also includes a sequence valve 250 coupled to an output 229 of shuttle valve network 231. An output 256 of the sequence valve 250 is hydraulically coupled to port 206 of travel brake 205, and automatically controls engagement and release of travel brake 205 as is discussed below.

In an illustrative embodiment, shuttle valve network 231 includes three shuttle valves 232, 238 and 245. Inputs 233 and 234 of shuttle valve 232 are hydraulically coupled to respective outputs 220 of valves 215A and 215B, while inputs 235 and 236 of shuttle valve 238 are hydraulically coupled to respective outputs 220 of valves 215C and 215D. Outputs 239 and 240 of shuttle valves 232 and 238 act as inputs to shuttle valve 245. An output 229 of shuttle valve 245 is hydraulically coupled to sequence valve 250, and acts as a pilot pressure port to move sequence valve 250 to a position which is different from the bias position imparted by bias spring 251. By adding the three shuttle valves and a sequence valve to travel controller 200, the ability to send a pressure signal to control hydraulic travel brake(s) 205 is provided. With the three shuttle valves networked to the four output ports 220/222 of the travel controller, the shuttle valve network 231 outputs at output port 229 the highest pressure of the four ports 220/222 to the sequence valve as a pilot pressure.

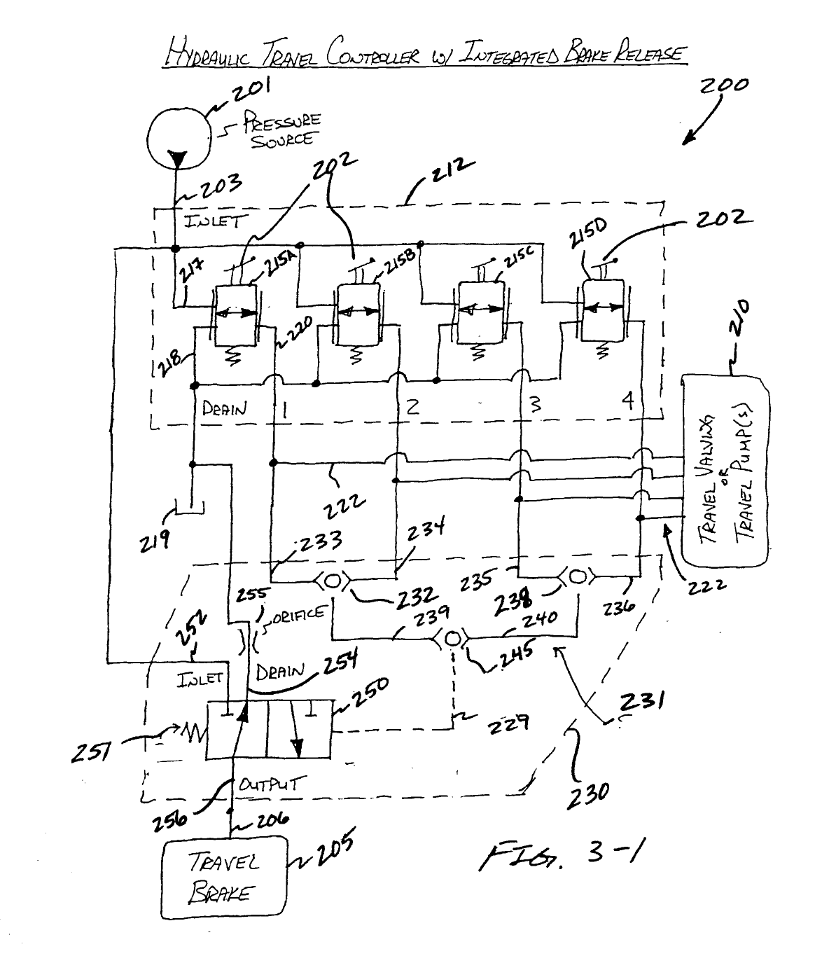

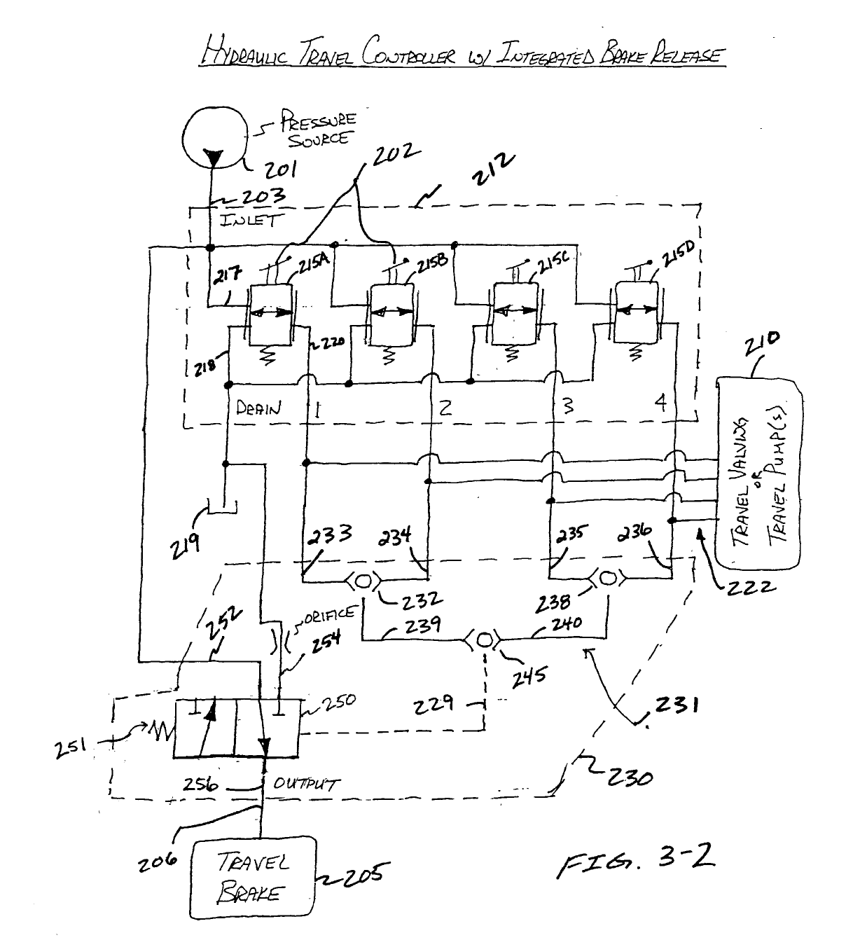

The sequence valve 250 includes an inlet 252, a drain 254 and an output or outlet 256. Inlet 252 of sequence valve 250 is hydraulically coupled to pressure source 201 to maintain a high pressure side. Outlet 256 of sequence valve 250 is connected to the travel brake control port 206. Drain 254 is connected to system tank 219 through orifice 255. Spring 251 biases sequence valve 250 in a neutral position (shown in FIG. 3-1). In the neutral position, the travel brake port 206 of travel brake 205 is connected to drain port 254 of the sequence valve, and thus to a low pressure side which cannot overcome the bias force provided by spring 251. Thus, travel brake 205 remains engaged while sequence valve 250 is in the neutral position.

The sequence valve pilot pressure provided at output 229 of shuttle valve network 231 controls the sequence valve position, and thus engagement of the travel brake. When the sequence valve is in the neutral position shown in FIG. 3-1, the inlet 252 is blocked, and the outlet 256 is ported to the drain. When the sequence valve pilot pressure provided at output 229 of network 231 generates enough force to overcome the sequence valve bias spring, the sequence valve moves to the activated position shown in FIG. 3-2, and directs the pressure source 201 at the inlet port 252 to outlet port 256. In this active position shown in FIG. 3-2, the drain is blocked, and travel brake 205 is released, allowing travel of the machine 10. When the sequence valve pilot pressure drops to a predetermined level, the bias spring 251 will move the sequence valve back to its neutral position as shown in FIG. 3-1, and travel will again be halted. Orifice 255 can optionally be added in the sequence valve drain path to cause a delay in the return to neutral if desired.

Travel controller 200 can provide numerous benefits over existing travel controller configurations. For example, with travel controller 200, brake control is automatic. In other words, the brake is locked until the travel controller is actuated by the operator of machine 10. In accordance with some embodiments of the invention, the minimum sequence valve pilot pressure required to unlock or disengage the travel brake is a predetermined percentage of the minimum pressures required to begin travel. For example, the pilot pressure required to overcome the force of the bias spring can be set to eighty or ninety percent of the pressure required to cause movement of the vehicle so that the brake disengages prior to the machine having sufficient pressure built-up to begin travel.

Another advantage provided by travel controller 200 is that no external valving or switches are required. Further, a reduction in hydraulic plumbing and in system complexity and cost may be achieved. Further still, conclusion of the orifice presents undesirable brake drag, which maximizes brake life. Other advantages may also be obtained.

Although the present invention has been described with reference to preferred embodiments, workers skilled in the art will recognize that changes may be made in form and detail without departing from the spirit and scope of the invention.

What is claimed is:

1. A hydraulic travel controller for use in controlling travel of a hydraulically driven machine, the hydraulic travel controller comprising:
a travel control portion coupled to an operator mechanical user interface by a linkage, the travel control portion having an inlet hydraulically coupled to a pressure source, and providing a plurality of outputs for controlling travel of the machine;
a brake control portion hydraulically coupled to the plurality of outputs of the travel control portion and having an output hydraulically coupled to an input of a travel brake of the hydraulically driven machine, wherein in response to a pressure at one or more of the plurality of outputs of the travel control portion the brake control portion providing at the brake control portion output a pressure to the travel brake to thereby engage or disengage the travel brake.

2. The hydraulic travel controller of claim 1, wherein the brake control portion provides a high pressure to the travel brake to disengage the travel brake when a pressure at one or more of the plurality of outputs of the travel control portion exceeds a predetermined percentage of a minimum pressure required to initiate travel of the machine.

3. The hydraulic travel controller of claim 1, wherein the travel control portion includes a plurality of valves coupled to the operator mechanical user interface by the linkage, each of the plurality of valves comprising:
an inlet hydraulically coupled to the pressure source;
a drain hydraulically coupled to a system drain; and
an outlet hydraulically coupled to one of the plurality of outputs of the travel control portion for controlling travel of the machine.

4. The hydraulic travel controller of claim 3, wherein the plurality of outputs of the travel control portion of the hydraulic travel controller are coupled to at least one of travel valves and travel pumps for controlling travel of the machine.

5. The hydraulic travel controller of claim 4, wherein the brake control portion of the hydraulic travel controller includes a shuttle valve network having a plurality of inputs, each of the plurality of inputs of the shuttle valve network being coupled to one of the plurality of outputs of the travel control portion, the shuttle valve network providing an output having a pressure based upon a highest pressure at the plurality of outputs of the travel control portion.

6. The hydraulic travel controller of claim 5, wherein the plurality of valves of the travel control portion comprises four valves providing four outputs of the travel control portion, the shuttle valve network further comprising:
a first shuttle valve having first and second inputs coupled to first and second ones of the four outputs of the travel control portion, the first shuttle valve providing a first shuttle valve output having a pressure based upon a highest pressure at the first and second ones of the four outputs of the travel control portion;
a second shuttle valve having first and second inputs coupled to third and fourth ones of the four outputs of the travel control portion, the second shuttle valve providing a second shuttle valve output having a pressure based upon a highest pressure at the third and fourth ones of the four outputs of the travel control portion; and
a third shuttle valve having first and second inputs coupled to the outputs of the first and second shuttle valves, the third shuttle valve providing a third shuttle valve output having a pressure based upon a highest pressure at the first and second shuttle valve outputs and thereby based upon a highest pressure at the first, second, third and fourth ones of the four outputs of the travel control portion.

7. The hydraulic travel controller of claim 6, wherein the brake control portion is configured to provide the pressure at the brake control portion output to the travel brake in response to the pressure of the third shuttle valve output.

8. The hydraulic travel controller of claim 7, wherein the brake control portion further comprises a sequence valve, the sequence valve comprising an inlet port, a drain port and an outlet port, the outlet port being coupled to the outlet of the brake control portion and thereby to the travel brake, wherein when the pressure at the third shuttle valve output is below a predetermined value the sequence valve is biased to connect the outlet port and the outlet of the brake control portion to drain.

9. The hydraulic travel controller of claim 8, wherein when the pressure at the third shuttle valve output is above the predetermined value the sequence valve moved to connect the outlet port and the outlet of the brake control portion to the pressure source.

10. A hydraulically driven machine including the hydraulic travel controller of claim 1.

11. A mini-excavator including the hydraulic travel controller of claim 1.
